(19) United States
(12) Patent Application Publication
(10) Pub. No.: US 2026/0104282 A1
(43) Pub. Date: Apr. 16, 2026

(54) REGISTER GUARD FOR PROTECTING AN ENCODER-TYPE REGISTER OF A WATER METER

(71) Applicants: Arthur A. Hendey, SR., Lake Havasu City, AZ (US); Alan Hendey, Lake Havasu City, AZ (US)

(72) Inventors: Arthur A. Hendey, SR., Lake Havasu City, AZ (US); Alan Hendey, Lake Havasu City, AZ (US)

(21) Appl. No.: 18/912,901

(22) Filed: Oct. 11, 2024

(51) Int. Cl. G01F 15/063; G01F 15/00

(52) U.S. Cl. CPC G01F 15/063; G01F 15/007

(57) ABSTRACT

Disclosed is a water meter to be coupled to a water source and having a register to receive and store information concerning the volume of water flowing through the water meter. The register has an encoder to generate RF signals corresponding to the information received and an antenna to transmit the RF signals to a remote data collection and billing site. A register guard is detachably connected to the water meter to enclose and protect the register, the encoder, and the antenna from unauthorized access, damage and theft. An RF filter having RF signal escape holes formed therein extends across and covers the top of the register guard so that the RF signals are directed vertically upward and outwardly therefrom, while limiting the level of potentially harmful radiation being transmitted from the antenna into the atmosphere.

### BACKGROUND OF THE INVENTION

### 1. Field of the Invention

This invention relates to a detachable register guard to enclose and prevent unauthorized access to an encoder-type register that stores and transmits data regarding the consumption of water flowing through a water meter to which the register guard is connected. The register guard of this invention advantageously prevents the encoder-type register of the water meter from being altered, damaged or stolen.

### 2. Background Art

Residential and commercial users who receive water from a utility or municipality usually have a water meter connected to the water line to monitor water consumption. Some conventional water meters have a visual read-only register that measures the volume of water being consumed by a user. In this regard, it is necessary that the register be read on a regular basis so that the water supplier can bill the user for its consumption. To accomplish the foregoing, a meter reader typically travels from one water meter to the next throughout the day to make a visual inspection of the register and record the numerical values indicated thereby.

However, such a technique of employing meter readers to personally visit and visually inspect the read-only register of every water meter along a route is time consuming, inefficient, and relatively expensive and may result in inaccurate readings being taken by a tired or inattentive worker.

To overcome this problem, it has been known to attach an encoder-type register to the water meter so that readings collected by the register can be automatically sent via antenna over a wireless transmission path to a remote data processing site, such that users can be accurately charged for the water they consume. By way of example, reference can be made to U.S. Pat. No. 8,041,723 issued Nov. 8, 2011, for one example of a combination water meter and encoder-type register. However, it is also known for thieves and other miscreants to alter, damage or steal the register, resulting in the water meter having to be taken out of service by which consumers are denied the ability to use the water being supplied by way of the meter. Accordingly, what is desirable is a means to be detachably connected to the water meter to safeguard the register and prevent an unauthorized access thereto.

### SUMMARY OF THE INVENTION

In general terms, a register guard is disclosed to be detachably connected to a water meter to enclose and protect an encoder-type register of the water meter that collects and stores information regarding the volume of water flowing through the water meter and consumed by a user. The water meter is commonly used to measure the consumption of potable water being supplied to a home or business. The water may also be coupled to a fire hydrant to measure the water consumed by a local fire authority or by those in the construction industry. The encoder-type register of the water meter receives information regarding water consumption from a data logger over a wireless transmission path and then transmits the information from an antenna to a remote processing center at which users are billed for the water they consume.

The register guard of this invention includes a hollow cylindrical body to enclose the register of the water meter. The body is preferably manufactured from an RF signal reflecting material. The top of the cylindrical body of the register guard is open, and a slot is formed through the body below the open top. The slot is sized to slidably receive an RF shield of a disc-like RF filter that extends across and covers the open top of the body. A plurality of RF signal escape holes are formed through the RF shield so that RF signals being emitted by the antenna of the encoder-type register are confined to the cylindrical body of the register guard and reflected vertically upward therefrom through the signal escape holes of the RF shield. A locking tab projects from the RF shield of the RF filter through the slot so as to lie outwardly from the body of the register guard. A hole is formed through the locking tab within which to receive a lock to block the withdrawal of the RF filter and thereby prevent the separation of the RF filter from the body of the register guard.

The bottom of the hollow cylindrical body of the register guard is closed by an anchor base. The anchor base has a flat plate that is welded to and extends across the bottom of the register guard. A tail projects from the flat plate of the anchor base on which the data logger is mounted. Axially aligned bolt holes are formed in a flat plate and in the top of the water meter. With the anchor base laying on top of the water meter, bolts are rotated through the bolt holes to hold the anchor base atop the water meter with the register guard standing upwardly from the anchor base to enclose and safeguard the register.

### BRIEF DESCRIPTION OF THE DRAWINGS

FIG. 1 is a perspective view of a water meter of the kind having an encoder-type register and a register guard according to a preferred embodiment of this invention to enclose and prevent unauthorized access to the register;

FIG. 2 shows a side view of the water meter with the register guard of FIG. 1 enclosing the encoder-type register of the water meter;

FIG. 3 is an exploded view of the register guard to be detachably connected to the water meter of FIGS. 1 and 2;

FIG. 4 shows an RF filter to be removably attached across the top of the register guard of FIG. 3; and

FIG. 5 shows the register guard with the RF filter of FIG. 4 removably attached thereto.

### DESCRIPTION OF THE PREFERRED EMBODIMENT

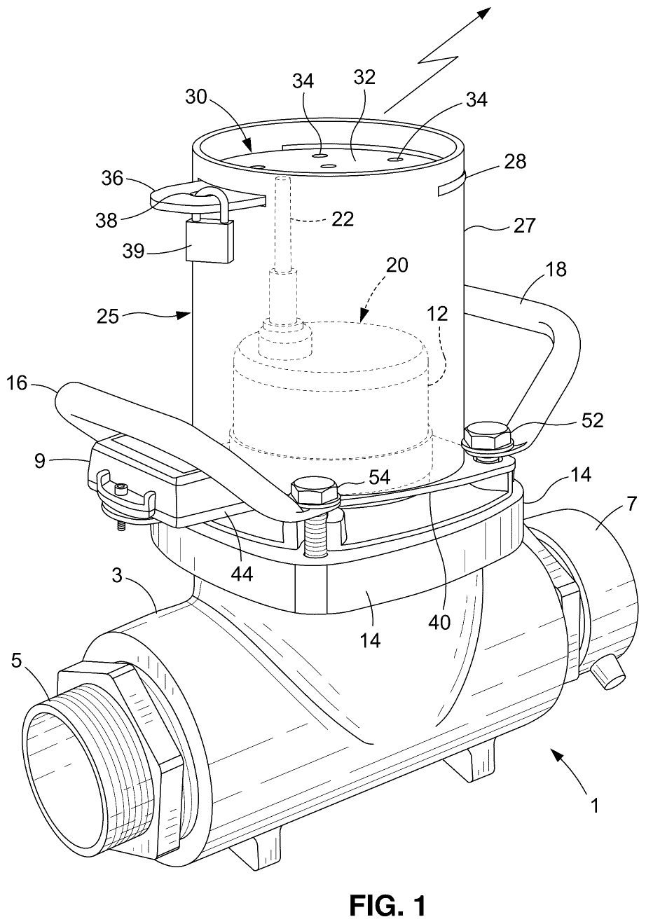

Referring concurrently to FIGS. 1-3 of the drawings, there is shown a water meter 1 of the kind that measures the consumption of water so that billing agencies can issue invoices to consumers which accurately reflect their water use. The water meter 1 shown is a commercially available fire hydrant water meter such as that distributed by Hendy & Sons of Beaumont, California under the trademark DOMINATOR® By way of example, the water meter 1 is coupled to a fire hydrant so as to measure the water that flows therethrough in a single direction to be consumed by a local fire authority or by those in the construction and building industries who fill water trucks from which the water is sprayed on land under development. The water meter 1 can also be used for measuring potable water consumption, the temporary metering of irrigation and well pumping. Therefore, the particular application water meter 1 should not be considered to limitation of the of this invention.

The water meter 1 is manufactured with a hard anodized aluminum body 3 with standard threaded and swivel couplings 5 and 7 located at opposite inlet and outlet flow ends. A data logger 9 is located at the outlet flow end adjacent to the outlet coupling 7 to monitor the geographic location of the water meter and collect data (e.g., usage, backflow, leaks, and damage) regarding the water which flows through the water meter. One such data logger 9 that is suitable for use herein is commercially available from Metron Company of Boulder, Colorado. The data logger 9 communicates with an encoder 12 of a commercially available encoder-type register 20 by way of a wireless communications path. The register 20 is seated on a stand 14 above the top of body 3 at which to store data collected by the data logger 9. The encoder 12 of the register 20 has an antenna 22 by which the data stored by the register is transmitted to a remote billing agency. The register 20 provides an efficient way to automatically read and record a user's water consumption without the requirement that a meter reader personally visit and inspect each water meter of each user. A pair of upstanding stainless-steel handles 16 and 18 are connected to the stand 14 to be grasped and lifted to enable the water meter 1 to be transported from place-to-place.

One commercially available encoder 12 that is suitable for use herein is the INNOV8-VN encoder. This encoder uses a 4G cell satellite for GPS tracking. The antenna 22 of the encoder 12 is adapted to communicate with radio systems using an AWWA protocol. In particular, the encoder 12 interfaces with a Verizon network to securely deliver readings, high resolution interval data, and diagnostic data to a cloud-based meter data management system (NDNSN). Both utilities and consumers can access this data via the WATER SCOPE® web portal and/or by email notifications.

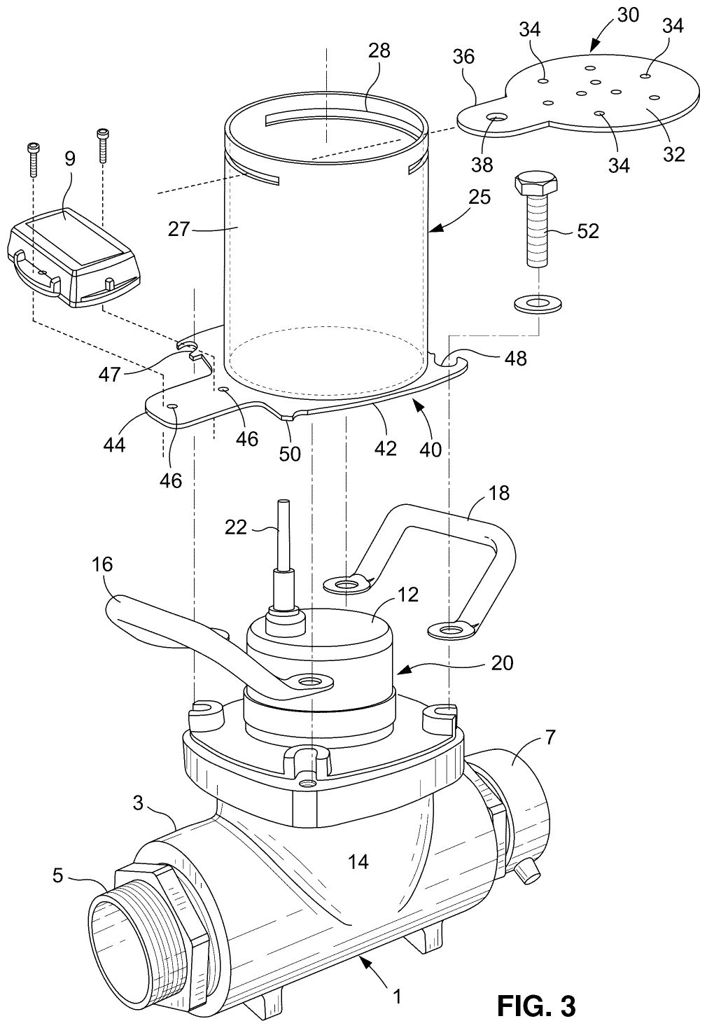

In accordance with the improvement of this invention, a register guard 25 is detachably connected to the water meter 1 to enclose and safeguard the register 20 in order to prevent damage to the register and the encoder thereof. As is best shown in FIG. 3, the register guard 25 includes a hollow cylindrical body 27 having an open top and being preferably manufactured from aluminum or any other RF signal reflective material. As will be disclosed in greater detail hereinafter, the register guard 25 minimizes signal distortion and ensures that the signals being emitted by the antenna 22 of the register 20 are reflected towards the top of the guard from which to be transmitted to a remote location. Moreover, the body 27 of the register guard 25 that encloses the register 20 limits the escape of potentially harmful radiation into the atmosphere.

What is even more, and as another important advantage of this invention, the register guard 25 herein disclosed prevents unauthorized access to and tampering with or stealing the register 20 enclosed by the body 27 of guard 25. This advantage avoids the possibility that readings of the register 20 can be altered to report a lower than actual indication of water consumption and a corresponding reduction in the true costs to be paid to a municipality for the use of its water. Likewise, a stolen register will have to be replaced which adds to maintenance costs and often requires that the water meter be taken out of service resulting in the likelihood of an interruption in the flow of water to be supplied to a user.

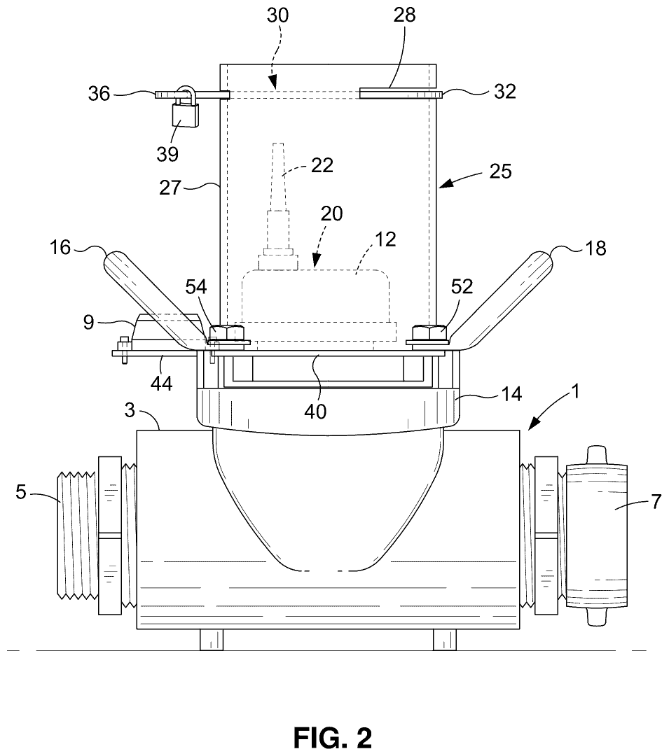

A slot 28 is cut through the cylindrical body 27 of the register guard 25 below the open top thereof. The length of the slot 28 corresponds to an angle of approximately 270 degrees extending around the body 27. The slot 28 is sized for the removable receipt therethrough of a disc-like RF filter 30. The filter 30 is preferably manufactured from a composite or other suitable material that is capable of reducing the level of the RF radiation that is emitted from the encoder 12 so as not to adversely affect the health of individuals in the vicinity of the water meter. The filter 30 includes an RF shield 32 that is pushed inwardly through the slot 28 to lie across and cover the open top of the cylindrical body 27 of the register guard 25. A plurality of RF signal escape holes 34 are formed through the RF shield 32 of filter 30. A locking tab 36 extends from the RF shield 32 through the slot 28 so as to lie outside the body 27 of register guard 25. The locking tab 36 is responsive to a pushing force applied thereto so as to cause the RF shield 32 to slide into the hollow body 27 of register guard 25 via the slot 28 formed therein. A hole 38 is made in the locking tab 36 to receive a lock (designated 39 in FIGS. 1 and 2) therethrough by which to prevent a withdrawal of the RF shield 32 and the removal of the RF filter 30 from the hollow body 27 of the register guard 25.

By virtue of the foregoing, unauthorized access is denied to the register 20 that is enclosed by the register guard 25 and covered by the RF filter 30. Accordingly, it is no longer easy for thieves or other miscreants to alter, damage or steal the register 20 or the encoder 12 and its antenna 22 which has been known to cause the water meter 1 to be taken out of service and/or affect the accuracy of the costs being charged to users for the value of the water they consume.

The RF reflective material of the cylindrical body 27 of the register guard 25 prevents a distortion of the signals being transmitted from the data logger 9 to the encoder 12 of the register 20. The signal escape holes 34 formed through the RF shield 32 of filter 30 advantageously enable the RF output signals being emitted by the antenna 22 of the encoder 12 to be reflected in a generally uniform vertically upward direction outwardly from the register guard 25 for transmission to a remote data collection and billing site.

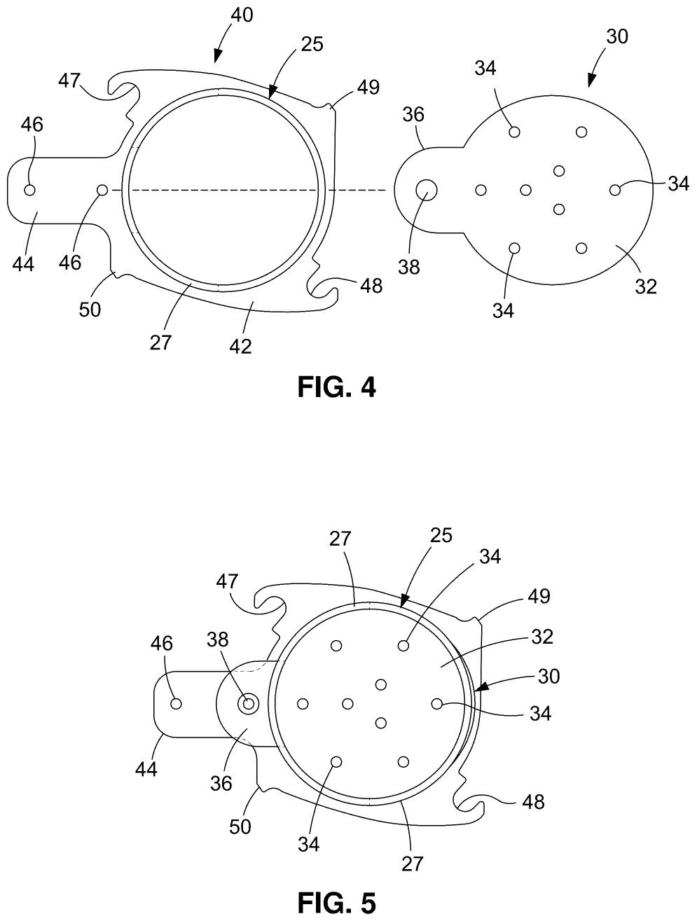

Turning now to FIGS. 4 and 5 of the drawings, there is shown an anchor base 40 by which to detachably connect the cylindrical body 27 of the register guard 25 to the top of the water meter 1. The anchor base 40 is a flat plate 42 that is welded to the bottom of the body 27. In this regard, the cylindrical body 27 of register guard 25 is closed at its top by means of the aforementioned RF shield 32 of the RF filter 30 sliding through the semi-circumferential slot 28 formed therein. The cylindrical body 25 is also closed as its opposite end by means of the anchor base 40 being welded across the bottom thereof.

The flat plate 42 of the anchor base 40 has a tail 44 extending outwardly therefrom. The tail 44 is sized to permit the data logger (designated 9 in FIG. 1) to be seated thereon outside the body 27 of the register guard 25 and held close to the encoder 12 of the register 20 in the manner shown in FIGS. 1 and 2. Holes 46 are formed through the tail 44 to receive fasteners by which to connect the data logger 9 to the anchor base 40.

The flat plate 42 of anchor base 40 also has a pair of bolt pass-through openings 47 and 48 formed therein and located at a first pair of diagonally opposite corners. Located at a second pair of diagonally opposite corners of the plate 42 of anchor base 40 are a pair of attachment flanges 49 and 50. With the anchor base 40 laying on the stand 14 at the top of the water meter and the register guard 25 standing upwardly from the anchor base and enclosing the encoder-type register 20 so as shown in FIGS. 1 and 2, a first pair of threaded bolts 52 (only one of which being shown) are moved through the bolt pass-through openings 47 and 48 formed in the anchor base 40 for receipt by a corresponding first pair of axially aligned bolt holes that are formed in the stand 14 at the top of the water meter. Likewise, a second pair of threaded bolts 54 (only one of which being shown) are moved past the anchor base 40 for receipt by a corresponding second pair of threaded bolt holes in stand 14 while at the same time engaging the attachment flanges 49 and 50 of the anchor base. The first and second pairs of bolts 52 and 54 perform the dual functions of connecting the register guard 25 as well as the pair of handles 16 and 18 to the top of the water meter 1.

By virtue of the foregoing, with the water meter 1 in its ready to use configuration in the manner shown in FIGS. 1 and 2, the anchor base 40 of the register guard 25 is detachably connected by bolts 52 and 54 to the top of the water meter at the stand 14 so that the register 20 is enclosed and protected by the body 27 of guard 25 to avoid access to, damage and the theft thereof. Moreover, the radiation produced by the RF signals being emitted from the antenna 22 of the encoder 12 that is located inside the body 27 of register guard 25 and released into the atmosphere through the RF escape holes 34 of the RF filter 30 will be limited by the body to a safe level.

1. A combination comprising:
a water meter to be connected to a source of water and having a register to receive and record information regarding the volume of water flowing through the water meter from the source, the register including an encoder to generate and transmit RF signals corresponding to the information received by the register; and
a register guard to be connected to the water meter to surround the register and the encoder and thereby prevent unauthorized access thereto.

2. The combination recited in claim 1, wherein the register guard is manufactured from an RF signal reflecting material.

3. The combination recited in claim 1, wherein the register guard has a top and a bottom and an RF shield extending across and covering the top, said RF shield having at least one RF signal escape hole to permit the RF signals generated by said encoder to be transmitted outwardly from the register guard and into the atmosphere by way of said RF escape hole.

4. The combination recited in claim 3, wherein the encoder of the register has an antenna to transmit the RF signals generated by said encoder into the atmosphere by way of the at least one RF signal escape hole of the RF shield of said register guard.

5. The combination recited in claim 3, wherein the RF shield that extends across and covers the top of said register guard is removable from said register guard.

6. The combination recited in claim 5, wherein the register guard has a hollow body within which the register and the encoder thereof are surrounded, said hollow body having a slot formed therein through which the RF shield of said register guard is slidably and removably received.

7. The combination recited in claim 6, wherein the RF shield of said register guard has a locking tab that lies outside the hollow body of said register guard when said RF shield is moved through the slot formed in said hollow body to extend across and cover the top of said register guard, said locking tab have a hole formed therein within which to receive a lock to prevent the removal of said RF shield from the hollow body of said register guard.

8. The combination recited in claim 3, wherein the body of said register guard has an anchor base extending across the bottom thereof, said anchor base attached to the water meter to connect said register guard thereto with the register and the encoder thereof enclosed by said body.

9. The combination recited in claim 8, wherein each of the anchor base extending across the bottom of said register guard and the water meter has a plurality of holes formed therein, said combination further comprising a corresponding plurality of the fasteners located through respective ones of the plurality of holes formed in said anchor base for receipt by respective ones of the plurality of holes formed in the water meter by which said register guard is connected to said water meter.

10. The combination recited in claim 9, further comprising at least one handle connected to the water meter to which a lifting force is applied to lift and transport said water meter from place-to-place, said handle connected to the water meter by at least some of said plurality of fasteners that connect said register guard to the water meter.

11. A combination comprising:
A water meter to be connected to a source of water and having a register to receive and record information regarding the volume of water flowing through the water meter from the source, the register including an encoder to generate RF singles corresponding to the information received by the register and an antenna by which to transmit the RF signals to a remote location; and
a register guard having a hollow body within which to enclose the register and the encoder and thereby prevent unauthorized access thereto, said register guard also having an RF shield extending across said hollow body above said register, said RF shield including at least one RF signal escape hole to permit the RF signals generated by said encoder to be transmitted by said antenna outwardly from said body to the remote location by way of said RF escape hole.
